(19) United States
(12) Patent Application Publication
(10) Pub. No.: US 2005/0088578 A1
(43) Pub. Date: Apr. 28, 2005

(54) Optically compensated bend mode liquid crystal display

(76) Inventors: Chang-Hun Lee, Yongin-si (KR); Jong-Lae Kim, Seoul (KR)

Correspondence Address: F. CHAU & ASSOCIATES, LLC, 130 WOODBURY ROAD, WOODBURY, NY, 11797, US

(21) Appl. No.: 10/931,184

(22) Filed: Aug. 31, 2004

(30) Foreign Application Priority Data
Sep. 29, 2003 (KR) 2003-67342

(51) Int. Cl. G02F 1/1343

(52) U.S. Cl. 349/38

(57) ABSTRACT

A liquid crystal display comprises a first substrate including a plurality of storage electrode lines and a plurality of pixel electrodes formed thereon, wherein the plurality of pixel electrodes and the plurality of storage electrode lines create a storage capacitance (Cst) by overlapping each other, and a second substrate positioned opposite the first substrate including a common electrode formed thereon, wherein a capacitance between the plurality of pixel electrodes and the common electrode is a liquid crystal capacitance (Clc) and a ratio of the storage capacitance to the liquid crystal capacitance (Cst/Clc) is about 0.77.

### BACKGROUND OF THE INVENTION

(a) Technical Field

The present disclosure relates to a liquid crystal display of the Optically Compensated Bend (OCB) mode.

(b) Discussion of the Related Art

A liquid crystal display (LCD) is one of the most widely used flat panel displays. An LCD includes two panels provided with field-generating electrodes, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

Recently, research with regard to an Optically Compensated Bend (OCB) mode LCD has been conducted. It is known that the OCB mode LCD has features including high response speed and wide viewing angle. In an OCB mode LCD, the liquid crystal molecules gradually bend to an orientation substantially perpendicular to opposing substrates when approaching a central plane between the substrates.

The OCB mode LCD exhibits a cusp the time-transmittance curve. The cusp is a period in which an increase of transmittance is stopped momentarily. After the cusp, transmittance increases again. The cusp occurs in the period for measuring response time, which is the period in which the transmittance changes from 10% to 90%. Therefore, response time of the OCB mode. LCD is increased due to the cusp.

### SUMMARY OF THE INVENTION

A liquid crystal display, in accordance with an embodiment of the present invention, comprises a first substrate including a plurality of gate lines and a plurality of storage electrode lines formed thereon, a gate insulating layer formed on the plurality of gate lines and the plurality of storage electrode lines, a passivation layer formed on the gate insulating layer, a plurality of pixel electrodes formed on the passivation layer, wherein the plurality of pixel electrodes and the plurality of storage electrode lines create a storage capacitance (Cst) by overlapping each other, a second substrate positioned opposite the first substrate including a common electrode formed thereon, and a liquid crystal layer interposed between the first and second substrates, wherein a capacitance between the plurality of pixel electrodes and the common electrode is a liquid crystal capacitance (CIc) and a ratio of the storage capacitance to the liquid crystal capacitance (Cst/Clc) is about 0.77.

The ratio of the storage capacitance to the liquid crystal capacitance (Cst/Clc) may be greater than or equal to 0.77. The liquid crystal layer may include a plurality of liquid crystals aligned to be driven in an optically compensated bend mode. The plurality of gate lines and the plurality of storage electrode lines may have a thickness of about 1000 Å to about 3500 Å. The gate insulating layer may have a thickness of about 3500 Å to about 4500 Å. The passivation layer may have a thickness of about 1500 Å to about 2500 Å. A cell gap of the liquid crystal layer may be less than or equal to about 5 μm. A ratio (Clc_{white}/Clc_{black}) of the liquid crystal capacitance in a white state (Clc_{white}) to the liquid crystal capacitance in a black state (Clc_{black}) may be about 0.814 and greater than or equal to 0.814.

The liquid crystal display may further comprise a plurality of gate electrodes formed on the first substrate, a plurality of semiconductor islands formed on the gate insulating layer so as to overlap the plurality of gate electrodes, a plurality of first ohmic contacts formed on a first portion of the plurality of semiconductor islands, a plurality of second ohmic contacts formed on a second portion of the plurality of semiconductor islands, a plurality of data lines including a plurality of source electrodes formed on the plurality of first ohmic contacts, and a plurality of drain electrodes formed on the plurality of second ohmic contacts. A thickness of each semiconductor island of the plurality of semiconductor islands may be about 800 Å to about 1500 Å. A thickness of each ohmic contact of the plurality of first and second ohmic contacts may be about 500 Å to about 800 Å. A thickness of each data line of the plurality of data lines and a thickness of each drain electrode of the plurality of drain electrodes may be about 1500 Å to about 3000 Å. The plurality of data lines and the plurality of drain electrodes may extend onto the gate insulating layer.

A liquid crystal display, in accordance with an embodiment of the present invention, comprises a first substrate including a plurality of storage electrode lines and a plurality of pixel electrodes formed thereon, wherein the plurality of pixel electrodes and the plurality of storage electrode lines create a storage capacitance (Cst) by overlapping each other, and a second substrate positioned opposite the first substrate including a common electrode formed thereon, wherein a capacitance between the plurality of pixel electrodes and the common electrode is a liquid crystal capacitance (Clc) and a ratio of the storage capacitance to the liquid crystal capacitance (Cst/Clc) is about 0.77.

A liquid crystal display, in accordance with an embodiment of the present invention, comprises a first substrate including a plurality of gate lines and a plurality of storage electrode lines formed thereon, a gate insulating layer formed on the plurality of gate lines and the plurality of storage electrode lines, wherein the gate insulating layer has a thickness of about 3500 Å to about 4500 Å, a passivation layer formed on the gate insulating layer, wherein the passivation layer has a thickness of about 1500 Å to about 2500 Å, a plurality of pixel electrodes formed on the passivation layer, wherein the plurality of pixel electrodes and the plurality of storage electrode lines overlap each other, and a second substrate positioned opposite the first substrate including a common electrode formed thereon.

### BRIEF DESCRIPTION OF THE DRAWINGS

Preferred embodiments of the present invention can be understood in more detail from the following descriptions taken in conjunction the accompanying drawings, in which:

FIG. 1A is a layout view of a liquid crystal display according to an embodiment of the present invention.

FIG. 1B is a sectional view of the LCD shown in FIG. 1A taken along the line Ib-Ib′.

FIG. 2A is a layout view of a liquid crystal display according to an embodiment of the present invention.

FIG. 2B is a sectional view of the LCD shown in FIG. 1A taken along the line IIb-IIb′.

FIG. 3 is a graph showing time-transmittance curves of LCDs according to conventional technology and an embodiment of the present invention.

FIG. 4A is a bar graph showing response times with regard to a gray succession in a conventional LCD.

FIG. 4B is a bar graph showing response times with regard to a gray succession in an LCD according to an embodiment of the present invention.

### DETAILED DESCRIPTION OF THE PREFERRED EMBODIMENTS

Preferred embodiments of the present invention will now be described more fully hereinafter with reference to the accompanying drawings, in which preferred embodiments of the invention are shown. The present invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

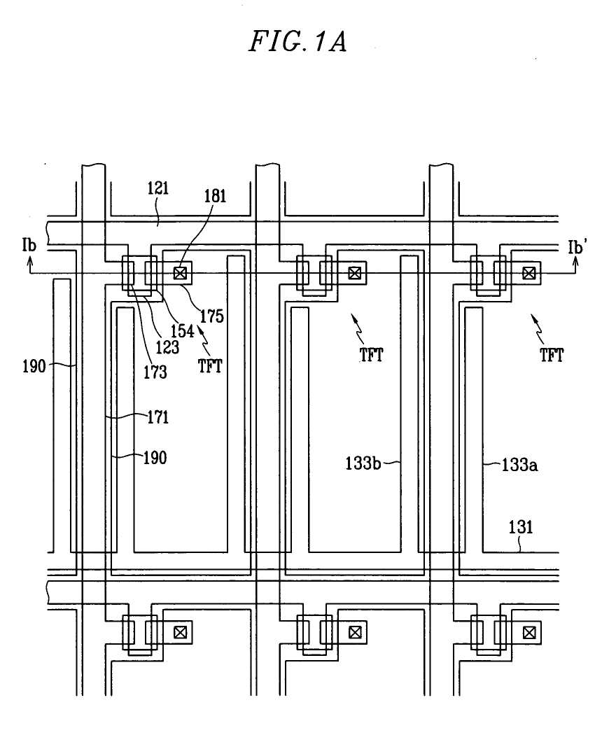

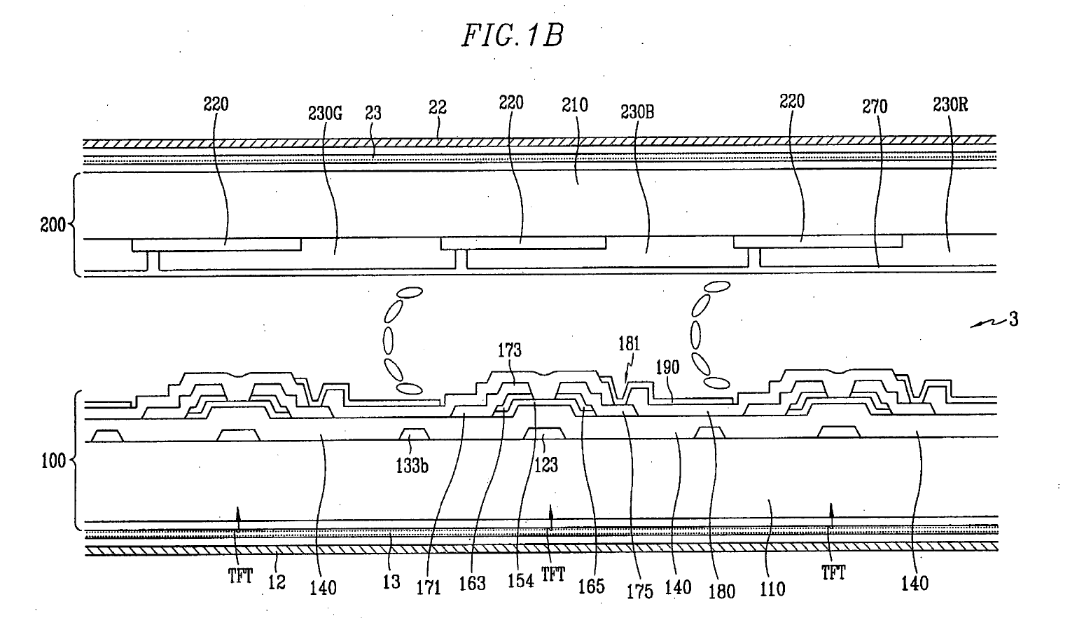

FIG. 1A is a layout view of a liquid crystal display according to an embodiment of the present invention. FIG. 1B is a sectional view of the LCD shown in FIG. 1A taken along the line Ib-Ib′.

An OCB mode LCD according to an embodiment of the present invention includes a thin film transistor (TFT) array panel 100, a color filter array panel 200, a liquid crystal layer 3, a pair of compensation films 13 and 23 respectively disposed on an outside surface of the panels 100 and 200, and a pair of polarizing films 12 and 22 respectively disposed on an outside surface of the compensation films 13 and 23.

A structure of the TFT array panel 100 will now be described.

A plurality of gate lines 121 and a plurality of storage electrode lines 131 made of, for example, Al, an Al alloy, Cr, a Cr alloy, Mo, an Mo alloy, Cr nitride, or Mo nitride are formed on an insulating substrate 110 to have a thickness of about 1,000 Å to about 3,500 Å.

The gate lines 121 extend substantially in a transverse direction and are separated from each other. The gate lines 121 transmit gate signals. A gate line 121 has a plurality of gate electrodes 123 and may have an expansion (not illustrated in drawings) for connecting to external circuit.

Each storage electrode line 131 extends substantially in the transverse direction, and includes a plurality of pair of storage electrodes 133a and 133b.

The gate lines 121 and the storage electrode lines 131 may have a multi-layered structure including two films having different physical characteristics, i.e., a lower film (not shown) and an upper film (not shown). One of the films is, for example, made of a low resistivity metal including an Al-containing metal such as Al or an Al alloy, for reducing signal delay or voltage drop in the gate lines 121 and the storage electrode lines 131. The other film is, for example, made of a material such as Cr, Mo, or an Mo alloy, which has good contact characteristics with other materials such as indium tin oxide (ITO) and indium zinc oxide (IZO). An example of a combination of the lower film material and the upper film material is Cr and an Al—Nd alloy.

A gate insulating layer 140, for example, made of silicon nitride (SiNx) or silicon oxide, is formed on the gate lines 121 and the storage electrode lines 131 to have a thickness of about 3,500 Å to about 4,500 Å.

A plurality of semiconductor islands 154, for example, made of hydrogenated amorphous silicon (“a-Si”) and overlapping the gate electrodes 123, are formed on the gate insulating layer 140. The semiconductor islands 154 have a thickness of about 800 Å to about 1,500 Å.

A plurality of ohmic contacts 163 and 165, for example, made of silicide or n+ hydrogenated a-Si heavily doped with n-type impurities, are formed on the semiconductor islands 154 to have a thickness of about 500 Å to about 800 Å.

A plurality of data lines 171 and a plurality of drain electrodes 175 are formed on the ohmic contacts 163 and 165, and the gate insulating layer 140. The data lines 171 and drain electrodes 175 are made of, for example, Al, an Al alloy, Cr, a Cr alloy, Mo, an Mo alloy, Cr nitride, or Mo nitride, and have a thickness of about 1,500 Å to about 3,000 Å.

Each data line 171 extends substantially in the longitudinal direction and includes a plurality of source electrodes 173 extending toward the drain electrodes 175. The intersection of the data lines 171 and the gate lines 121 defines pixel areas. The drain electrodes 175 are disposed on the ohmic contacts 165 and extend onto the gate insulating layer 140.

The data lines 171 and the drain electrodes 175 may have a multi-layered structure including two films having different physical characteristics. One of the films is, for example, made of a low resistivity metal including an Al-containing metal such as Al or an Al alloy for reducing signal delay or voltage drop in the data lines. other film(s) is(are), for example, made of a material such as Cr, Mo, or an Mo alloy, which has good contact characteristics with other materials such as indium tin oxide (ITO) and indium zinc oxide (IZO). A passivation layer 180 made of an insulating material such as silicon nitride and silicon oxide is formed on the data lines 171, the drain electrodes 175, and the semiconductor islands 154 to have a thickness of about 1,500 Å to about 2,500 Å.

The passivation layer 180 has a plurality of contact holes 181 exposing portions of the drain electrodes 175.

A plurality of pixel electrodes 190 are formed on the passivation layer 180. The pixel electrodes 190 are made of a transparent conductor such as ITO or IZO.

The pixel electrodes 190 and the storage electrode lines 131 form a storage capacitance (Cst) by overlapping each other.

The color filter panel 200 facing the TFT array panel 100 will now be described with respect to FIG. 1B.

A light blocking layer 220 overlapping the gate lines 121, the data lines 171, and the TFTs of the TFT array panel 100 is formed on an insulating substrate 210.

A plurality of red color filters 230R, green color filters 230G, and blue color filters 230B are formed on the insulating substrate 210 and portions of the light blocking layer 220, and are disposed in turn.

A common electrode 270 made of a transparent conductor such as ITO and IZO is formed on the color filters 230R, 230G, and 230B.

The color filter array panel 200 and the TFT array panel 100 are assembled to face each other and to form a gap between the panels 100 and 200. Liquid crystal material is filled into the gap between the panels 100 and 200 to form a liquid crystal layer 3 having a predetermined cell gap.

The pixel areas defined by the intersection of the gate lines 121 and the data lines 171 are classified into R pixel areas which correspond to the red color filters 230R, G pixel areas which correspond to the green color filters 230G, and B pixel areas which correspond to the blue color filters 230B.

Liquid crystals of the liquid crystal layer 3 are aligned to be driven in an OCB mode. That is, nematic liquid crystals are aligned to form a splayed array, a predetermined voltage is applied to transform the liquid crystals into a bend array, and then gray voltages are applied to control light transmittance. For aligning liquid crystals, alignment layers (not shown) are formed on the pixel electrode 190 and the common electrode 270 and are rubbed to predetermined directions. Here, the rubbing directions of the alignment layers are set to be the same to align the liquid crystals in a splayed array.

The polarizing films 12 and 22 are disposed to make the polarizing directions of the polarizing films 12 and 22 perpendicular to each other and to make angles of 45 degrees and 135 degrees with respect to the rubbing directions of the alignment layers.

The compensation films 13 and 23 are set to show the best compensation for green light.

The liquid crystal display shown in FIGS. 1A and 1B has one or both of the following properties.

The ratio (Cst/Clc) of the storage capacitance (Cst) with respect to the liquid crystal capacitance (Clc) is about 0.77, and, according to an embodiment of the invention, is greater than or equal to 0.77. The liquid crystal capacitance (Clc) is the capacitance between the pixel electrodes 190 and the common electrode 270. The ratio (Clc_{white}/Clc_{black}) of the liquid crystal capacitance in the white state (Clc_{white}) with respect to the liquid crystal capacitance in the black state (Clc_{black}) is about 0.814, and according to an embodiment of the present invention, greater than or equal to 0.814.

An LCD according to an embodiment of the present invention yields a much shorter response time than a conventional LCD. The shorter response time is due to the cusp of the time-transmittance curve appearing at a time after the transmittance is over 90% completed.

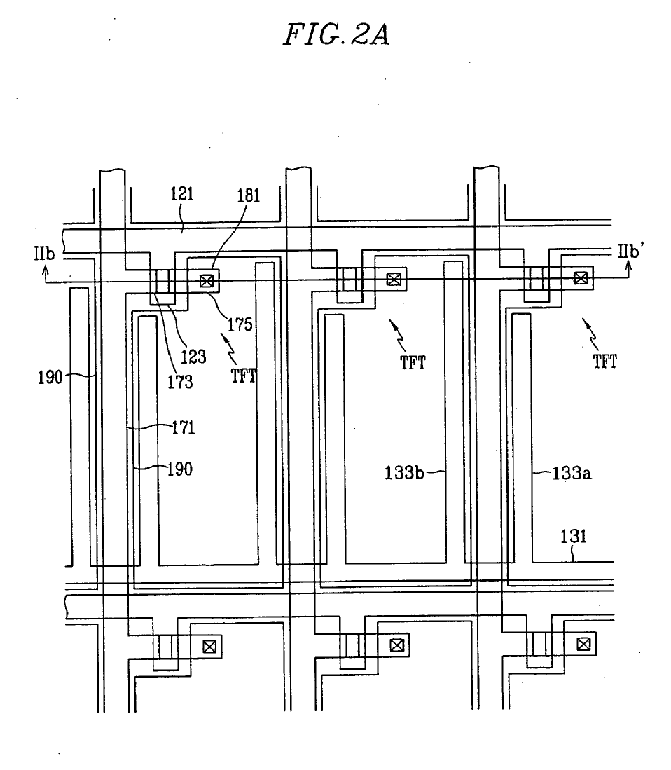

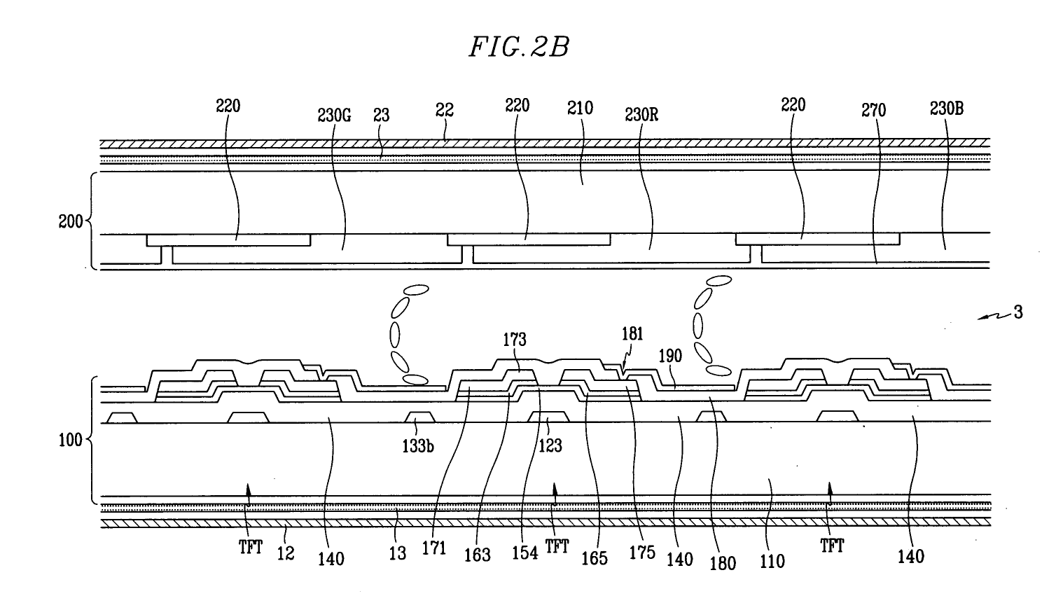

FIG. 2A is a layout view of a liquid crystal display according to an embodiment of the present invention. FIG. 2B is a sectional view of the LCD shown in FIG. 1A taken along the line IIb-IIb′.

The LCD shown in FIGS. 2A and 2B differs from the LCD shown in FIGS. 1A and 1B by some features of the thin film transistor array panel. The LCD of FIGS. 2A and 2B will be described with respect to these features of the TFT array panel, and discussion of same or similar features has been omitted.

Referring to FIG. 2B, the contact assistants 163 and 165 have substantially the same layout as the drain electrodes 175 and data lines 171 including the source electrodes 173 extending toward the drain electrodes 175. The semiconductor islands 154 have almost the same layout as the data lines 171 and the drain electrodes 175, except that the regions between the drain electrodes 175 and the source electrodes 173 are connected.

In other words, the data line 171 including the source electrode 173, which is, for example, a metal layer, forms a triple layer with the doped amorphous silicon layer 163 and the amorphous silicon layer 154. Similarly, the drain electrode 175, which is, for example, a metal layer, forms a triple layer with the doped amorphous silicon layer 165, and amorphous silicon layer 154. Each layer of the triple layers has substantially the same layout.

Such a structural feature is the result of a photo-etching process.

That is, the data lines 171 and the drain electrodes 175, the ohmic contacts 163 and 165, and the semiconductors 154 are patterned by a photo-etching process. The photo-etching process includes a step of forming a photoresist pattern of which thickness varies dependent on the position of the photoresist pattern. The portions of the photoresist pattern disposed on the data lines 171 and drain electrodes 175 are thicker than the portions of the photoresist pattern disposed between the drain electrodes 175 and the source electrodes 173.

A data metal layer, an ohmic contact layer, and a semiconductor layer are etched by using the photoresist layer as an etching mask. The etching process is as follows.

At first, exposed portions of the data metal layer are etched, and the ohmic contact layer and the semiconductor layer are sequentially etched. At this time, the photoresist pattern is also etched such that the thin portions of the photoresist pattern are removed to expose the data metal layer between the drain electrodes 175 and the source electrodes 173.

Residue of the photoresist pattern between the drain electrodes 175 and the source electrodes 173 is removed by ashing.

The exposed portion of the data metal layer and the portion of the ohmic contact layer thereunder are sequentially etched.

The liquid crystal display shown in FIGS. 2A and 2B has one or both of the following properties.

A ratio (Cst/Clc) of the storage capacitance (Cst) with respect to the liquid crystal capacitance (Clc) is about 0.77, and according to an embodiment of the present invention, greater than or equal to 0.77. A ratio (Clc_{white}/Clc_{black}) of the liquid crystal capacitance in the white state (Clc_{white}) with respect to the liquid crystal capacitance in the black state (Clc_{black}) is about 0.814, and according to an embodiment of the present invention, greater than or equal to 0.814.

An LCD according to an embodiment of the present invention shows a much shorter response time than a conventional LCD. The shorter response time is due to the cusp of the time-transmittance curve appearing at a time after the transmittance is over 90% completed.

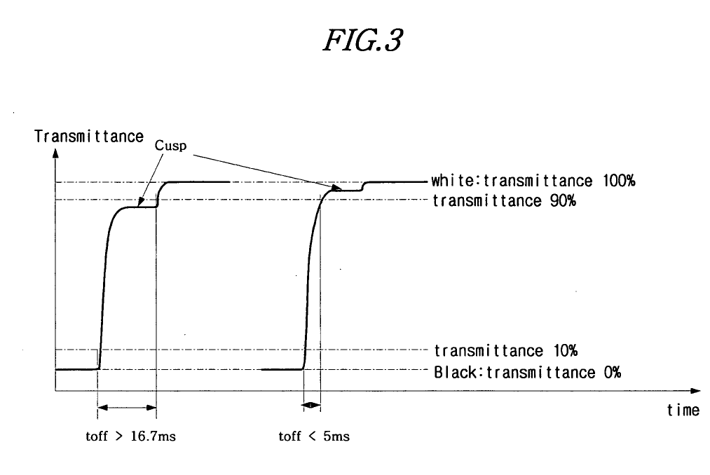

FIG. 3 is a graph showing time-transmittance curves of LCDs according to conventional technology and an embodiment of the present invention.

In FIG. 3, the left curve shows the time-transmittance variation of an LCD according to conventional technology, and the right curve shows the time-transmittance variation of an LCD according to an embodiment of the present invention.

Referring to the left curve of FIG. 3, the cusp occurs at a point before 90% of the transmittance has been completed. Therefore, the response time includes the duration of the cusp, which makes the response time over 16.7 ms. However, referring to the right curve of FIG. 3, the cusp occurs at a point after 90% of the transmittance has been completed. Therefore, the response time excludes the duration of the cusp. Accordingly, the response time is less than 5 ms.

The response time is, therefore, reduced by controlling the cusp so that it occurs at a point after 90% of the transmittance has been completed.

The cusp occurs as a result of fluctuation of the voltage applied to a liquid crystal layer after the thin film transistor (TFT) is turned off. The voltage fluctuation is induced by a variation of capacitance between the pixel electrode and the common electrode (liquid crystal capacitance), which is due to the rearrangement of liquid crystals.

The cusp may arise after the transmittance has been 90% completed by increasing the ratio (Cst/Clc) of storage capacitance (Cst) with respect to the liquid crystal capacitance (Clc), and/or by reducing the difference between the liquid crystal capacitance in the black state (Clc_{black}) and the liquid crystal capacitance in the white state (Clc_{white}).

The ratio Cst/Clc is increased to reduce the affect of the variation of Clc on the whole capacitance (Clc+Cst). If the ratio Cst/Clc is large enough, the variation of Clc due to the rearrangement of the liquid crystals does not result in a substantial change in the whole capacitance (Clc+Cst). Accordingly, the voltage fluctuation is also reduced. That is, the effect of Clc on V (V=Q/(Cst+Clc)) is reduced.

To increase the ratio Cst/Clc, one or a combination of the following methods may be applied. The width of the storage electrode line (e.g., storage electrode line 131) may be increased, the thickness of the insulating layer between the pixel electrode and the storage electrode line may be decreased (e.g., insulating layer 140, passivation layer 180), or the Clc may be decreased by reducing the cell gap of the liquid crystal layer or by using a liquid crystal material having a low dielectric constant.

Table 1 shows the results of an experiment to increase Cst by reducing the thickness of the insulating layer between the pixel electrode and the storage electrode line.

TABLE 1

| Thickness of the | Thickness under | |
|---|---|---|
| insulating layer | conventional conditions. | Decreased by 1500 Å |
| Cst | 0.566 | 0.736 (30% increase) |
| Response Time | 17.8 ms | 17.0 ms |
| Location of | 81.8% | 87.3% |
| cusp(Brightness %) | | |

In Table 1, Clc_{black} is 1.071.

As shown in Table 1, as the thickness of the insulating layer between the pixel electrode and the storage electrode is decreased by 1500 Å, the storage capacitance is increased by 30% and the response time decreases by 0.8 ms. The transmittance cusp is moved from a transmittance that is 81.8% completed to 87.3% completed. Accordingly, increasing the Cst/Clc decreases response time.

Referring to the Table 1, conditions to make the cusp occur at a point beyond 90% of the transmittance are analogized as follows.
Case 1(conventional): Cst=0.566, Clc_{black}=1.071 (Cst/Clc=0.53)-> location of the cusp: 81.8%
Case 2 (Decreasing insulating layer in 1500 Å): Cst=0.736, Clc_{black}=1.071 (Cst/Clc=0.69)-> location of the cusp: 87.3%

When the two cases are put into a proportional expression,
(0.69−0.53):(87.3−81.8)=(x−0.53):(90−81.8)
->0.16:5.5=x:8.2
->x=0.768

Accordingly, the cusp will occur at a point beyond 90% of the final transmittance when the following condition is satisfied.
Cst/Clc≧about 0.77

Reducing the difference between the liquid crystal capacitance in the black state (Clc_{black}) and the liquid crystal capacitance in the white state (Clc_{white}) reduces the variation of liquid crystal capacitance due to the rearrangement of liquid crystals, and, hence, reduces the voltage fluctuation causing the cusp. In other words, the ratio (Vw/Vb) of the voltage in the white state (Vw) with respect to the voltage in the black state (Vb) converges to 1 as the ratio between Clc_{black} and Clc_{white} approaches 1.

$$\frac{Vw}{Vb} = \frac{\frac{Q}{Clc ( white ) + Cst}}{\frac{Q}{Clc ( black ) + Cst}} = \frac{Clc ( black ) + Cst}{Clc ( white ) + Cst}$$

To decrease the difference between Clc_{black} and Clc_{white}, such that the ratio of Clc_{white}/Clc_{black} approaches 1, the cell gap of the liquid crystal layer can be reduced.

Table 2 shows the results of an experiment to decrease the difference between Clc_{black} and Clc_{white}, as measured by the ratio of Clc_{white}/Clc_{black}, by reducing the cell gap from about 5.3 μm to about 5.0 μm.

TABLE 2

| | | | Clc_{white}/ | Location | | |
|---|---|---|---|---|---|---|
| Cell gap | Clc_{black} | Clc_{white} | Clc_{black} | of cusp | On time | Off time |
| 5.3 μm | 1.071 | 0.845 | 0.789 | Below | 2˜3 ms | 3˜19 ms |
| | | | | 90% | | |
| 5.0 μm | 1.239 | 1.008 | 0.814 | Above | 2˜3 ms | 3˜5 ms |
| | | | | 90% | | |

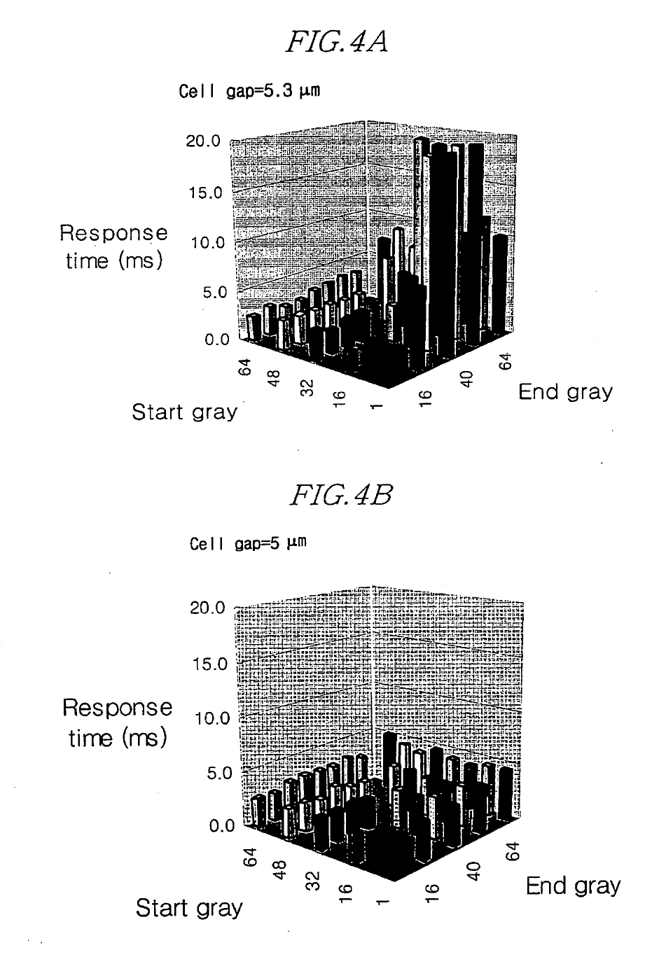

Referring to FIGS. 4A and 4B, response times with respect to various gray voltage transitions were measured according to the two conditions of Table 2.

FIG. 4A is a bar graph showing response times with regard to a gray succession in a conventional LCD, and FIG. 4B is a bar graph showing response times with regard to a gray succession in an LCD according to an embodiment of the present invention.

In FIGS. 4A and 4B, the start gray means a gray before transition, and the end gray means a gray after transition. The height of a bar which is located at a cross point of the extended lines of the start gray and end gray stands for the response time to change from the start gray to the end gray.

In FIG. 4A, some of the response times are over 15 ms. However, in FIG. 4B, all of the response times are less than 5 ms.

As illustrated by the above results, the cusp will occur at a point beyond 90% of the transmittance, when the following condition is satisfied.
Clc_{white}/Clc_{black}≧about 0.814

As described above, an LCD according to an embodiment of the present invention shows a much shorter response time than a conventional LCD. This shorter response time is due to the cusp of the time-transmittance curve appearing at a time after the transmittance has been over 90% completed. Although the illustrative embodiments have been described herein with reference to the accompanying drawings, it is to be understood that the present invention is not limited to those precise embodiments, and that various changes and modifications may be affected therein by one of ordinary skill in the related art without departing from the spirit and scope of the present invention. All such changes and modifications are intended to be included within the scope of the invention as defined in the appended claims.

1. A liquid crystal display, comprising:
a first substrate including a plurality of gate lines and a plurality of storage electrode lines formed thereon;
a gate insulating layer formed on the plurality of gate lines and the plurality of storage electrode lines;
a passivation layer formed on the gate insulating layer;
a plurality of pixel electrodes formed on the passivation layer, wherein the plurality of pixel electrodes and the plurality of storage electrode lines create a storage capacitance (Cst) by overlapping each other;
a second substrate positioned opposite the first substrate including a common electrode formed thereon; and
a liquid crystal layer interposed between the first and second substrates, wherein a capacitance between the plurality of pixel electrodes and the common electrode is a liquid crystal capacitance (Clc) and a ratio of the storage capacitance to the liquid crystal capacitance (Cst/Clc) is about 0.77.

2. The liquid crystal display as recited in claim 1, wherein the ratio of the storage capacitance to the liquid crystal capacitance (Cst/Clc) is greater than or equal to 0.77.

3. The liquid crystal display as recited in claim 1, wherein the liquid crystal layer includes a plurality of liquid crystals aligned to be driven in an optically compensated bend mode.

4. The liquid crystal display as recited in claim 1, wherein the plurality of gate lines and the plurality of storage electrode lines have a thickness of about 1000 Å to about 3500 Å.

5. The liquid crystal display as recited in claim 1, wherein the gate insulating layer has a thickness of about 3500 Å to about 4500 Å.

6. The liquid crystal display as recited in claim 1, wherein the passivation layer has a thickness of about 1500 Å to about 2500 Å.

7. The liquid crystal display as recited in claim 1, wherein a cell gap of the liquid crystal layer is less than or equal to about 5 μm.

8. The liquid crystal display as recited in claim 1, wherein a ratio (Clc_{white}/Clc_{black}) of the liquid crystal capacitance in a white state (Clc_{white}) to the liquid crystal capacitance in a black state (Clc_{black}) is about 0.814.

9. The liquid crystal display as recited in claim 8, wherein the ratio (Clc_{white}/Clc_{black}) of the liquid crystal capacitance in the white state (Clc_{white}) to the liquid crystal capacitance in the black state (Clc_{black}) is greater than or equal to 0.814.

10. The liquid crystal display as recited in claim 1, further comprising:
a plurality of gate electrodes formed on the first substrate;
a plurality of semiconductor islands formed on the gate insulating layer so as to overlap the plurality of gate electrodes;
a plurality of first ohmic contacts formed on a first portion of the plurality of semiconductor islands;
a plurality of second ohmic contacts formed on a second portion of the plurality of semiconductor islands;
a plurality of data lines including a plurality of source electrodes formed on the plurality of first ohmic contacts; and
a plurality of drain electrodes formed on the plurality of second ohmic contacts.

11. The liquid crystal display as recited in claim 10, wherein a thickness of each semiconductor island of the plurality of semiconductor islands is about 800 Å to about 1500 Å.

12. The liquid crystal display as recited in claim 10, wherein a thickness of each ohmic contact of the plurality of first and second ohmic contacts is about 500 Å to about 800 Å.

13. The liquid crystal display as recited in claim 10, wherein a thickness of each data line of the plurality of data lines is about 1500 Å to about 3000 Å.

14. The liquid crystal display as recited in claim 10, wherein a thickness of each drain electrode of the plurality of drain electrodes is about 1500 Å to about 3000 Å.

15. The liquid crystal display as recited in claim 10, wherein the plurality of data lines and the plurality of drain electrodes extend onto the gate insulating layer.

16. A liquid crystal display, comprising:
a first substrate including a plurality of storage electrode lines and a plurality of pixel electrodes formed thereon, wherein the plurality of pixel electrodes and the plurality of storage electrode lines create a storage capacitance (Cst) by overlapping each other; and
a second substrate positioned opposite the first substrate including a common electrode formed thereon, wherein a capacitance between the plurality of pixel electrodes and the common electrode is a liquid crystal capacitance (Clc) and a ratio of the storage capacitance to the liquid crystal capacitance (Cst/Clc) is about 0.77.

17. The liquid crystal display as recited in claim 16, wherein the ratio of the storage capacitance to the liquid crystal capacitance (Cst/Clc) is greater than or equal to 0.77.

18. The liquid crystal display as recited in claim 16, further comprising a liquid crystal layer interposed between the first and second substrates, wherein the liquid crystal layer includes a plurality of liquid crystals aligned to be driven in an optically compensated bend mode.

19. The liquid crystal display as recited in claim 18, wherein a cell gap of the liquid crystal layer is less than or equal to about 5 μm.

20. The liquid crystal display as recited in claim 16, wherein the plurality of storage electrode lines have a thickness of about 1000 Å to about 3500 Å.

21. The liquid crystal display as recited in claim 16, wherein a ratio (Clc_{white}/Clc_{black}) of the liquid crystal capacitance in a white state (Clc_{white}) to the liquid crystal capacitance in a black state (Clc_{black}) is about 0.814.

22. The liquid crystal display as recited in claim 21, wherein the ratio (Clc_{white}/Clc_{black}) of the liquid crystal capacitance in the white state (Clc_{white}) to the liquid crystal capacitance in the black state (Clc_{black}) is greater than or equal to 0.814.

23. A liquid crystal display, comprising:
a first substrate including a plurality of gate lines and a plurality of storage electrode lines formed thereon;
a gate insulating layer formed on the plurality of gate lines and the plurality of storage electrode lines, wherein the gate insulating layer has a thickness of about 3500 Å to about 4500 Å;
a passivation layer formed on the gate insulating layer, wherein the passivation layer has a thickness of about 1500 Å to about 2500 Å;
a plurality of pixel electrodes formed on the passivation layer, wherein the plurality of pixel electrodes and the plurality of storage electrode lines overlap each other; and
a second substrate positioned opposite the first substrate including a common electrode formed thereon.

24. The liquid crystal display as recited in claim 23, further comprising a liquid crystal layer interposed between the first and second substrates, wherein the liquid crystal layer includes a plurality of liquid crystals aligned to be driven in an optically compensated bend mode.

25. The liquid crystal display as recited in claim 24, wherein a cell gap of the liquid crystal layer is less than or equal to about 5 μm.

26. The liquid crystal display as recited in claim 23, wherein the plurality of gate lines and the plurality of storage electrode lines have a thickness of about 1000 Å to about 3500 Å.
